(19) United States
(12) Patent Application Publication
(10) Pub. No.: US 2002/0058174 A1
(43) Pub. Date: May 16, 2002

(54) Compound electrodes for electrochemical processes

(76) Inventor: Rodolfo Antonio Gomez, Urrbrae (AU)

Correspondence Address: CROWELL & MORING LLP, INTELLECTUAL PROPERTY GROUP, P.O. BOX 14300, WASHINGTON, DC, 20044-4300, US

(21) Appl. No.: 09/986,134

(22) Filed: Nov. 7, 2001

(30) Foreign Application Priority Data
Nov. 9, 2000 (AU) PR 1311
Mar. 13, 2001 (AU) PR 3648

(51) Int. Cl. H01M 8/10; H01M 4/90; H01M 4/86; H01M 4/96; C25B 9/00

(52) U.S. Cl. 429/31; 204/250; 204/260; 204/263; 204/272; 204/275.1; 429/40

(57) ABSTRACT

Compound electrodes are used instead of an anode and solution electrode and cathode and solution electrode in an electrochemical system that does not rely on a diaphragm or membrane directly between the anode electrode and the cathode electrode. The compound electrode consists of a solution electrode inside the anode or cathode electrode with a liquid or gel or electrolytic membrane located between the solution electrode and the anode or cathode electrode. The compound electrode may be used in a electrolytic cell, a fuel cell or a unipolar activation cell.

### TECHNICAL FIELD

This invention relates to an apparatus and a method of carrying out electrochemical reactions in metal extraction industries, industrial processes, and unipolar activation without a diaphragm or membrane or similar barrier directly between the anode electrode and the cathode electrode by using a compound electrode. These compound electrodes may also be applied to fuel cells and battery processes.

### BACKGROUND OF THE INVENTION

Our company has been granted Australian Patent No. 707701 and U.S. Pat. No. 5,882,502 concerning an electrolytic cell that operates without a diaphragm for carrying our electrochemical processes such as the extraction of metals and industrial processes such as the electrolysis of water to produce hydrogen and oxygen and the electrolysis of brine to produce chlorine, hydrogen, and caustic soda. The electronic circuit of the electrolytic system is completed by solution electrodes installed adjacent to the anode electrode and the cathode electrode and then externally connected by a conductor. The ionic circuit is carried out by transferring the electrolyte carrying the ions (anolyte) from the anode cell to the cathode cell. The catholyte may be recycled to the anode cell if required by the process.

This prior art has given faster reaction rates at less potential between the anode and the cathode and made agitation of the electrolytes more convenient and pressurization of the anode and cathode cells easier and safer.

It is an object of this invention to produce a compound electrode which may also be used with such processes as well as for other purposes.

It is appropriate to call the electrodes of this invention compound electrodes to distinguish them from composite electrodes that abound in the field. The composite electrode have one electrical lead as a normal electrode, for instance the gas diffusion electrode used for fuel cells. This electrode usually has a central metallic current collector and surrounded with graphite containing the platinum catalyst. The electrodes described in this invention usually consist of two electrodes, with electrons entering the first electrode and electrons leaving the second electrode. This invention is another method of carrying out electrochemical reactions at a faster rate and with less impedance by eliminating the diaphragm or membrane between the anode electrode and the cathode electrode. The diaphragm causes low reaction rates through the slow diffusion of the electrons or ions through the restricted passage through the diaphragm. Removal of the diaphragm will also allow convenience of mechanical mixing of solids-electrolyte mixtures and application of higher pressures required by some reactions.

### BRIEF DISCUSSION OF THE INVENTION

In one form therefore the invention is said to reside in a compound electrode for use in electrochemical processes comprising an inner electrical conductor electrode contained in an outer electrical conductor electrode, an electrically conducting liquid or gel or electrolytic membrane in contact with and sandwiched between the inner electrode and the outer electrode and electrical leads to the inner and outer electrodes for inlet and outlet of electrons.

Preferably an outer surface of the outer electrodes has a high specific surface area or is coated with material to protect the electrode or to act as a catalyst

In an alternative form the invention may be said to reside in an electrochemical cell having an anode cell and a cathode cell, a compound electrode being the anode in the anode cell and a compound electrode being the cathode in the cathode cell, wherein each of the compound electrodes includes an inner electrical conductor electrode contained in an outer electrical conductor electrode and an electrically conducting material in contact with and sandwiched between the inner electrode and the outer electrode, a positive terminal of a DC power source connected to the outer electrode of the anode electrode and the negative terminal to the outer electrode of the cathode electrode, the inner electrodes of the anode and the cathode being connected to each other by a wire conductor, means to deliver electrolyte to the anode cell and means to transfer discharge from the anode cell to the cathode cell and means to transfer the discharge of the cathode cell to the anode cell.

In an alternative form the invention may be said to reside in a unipolar activation cell having an anode cell and a cathode cell, a compound electrode being the anode electrode in the anode cell and a compound electrode being the cathode electrode in the cathode cell, wherein each of the compound electrodes includes an inner electrical conductor electrode contained in an outer electrical conductor electrode and an electrically conducting material in contact with and sandwiched between the inner electrode and the outer electrode, a positive terminal of a DC power source connected to the outer electrode of the anode electrode and the negative terminal to the outer electrode of the cathode electrode, the inner electrodes of the anode and the cathode being connected to each other by a wire conductor, means to supply an neutral anolyte to the anode cell and means to withdraw activated anolyte from the anode cell and means to supply an neutral catholyte to the cathode cell and means to withdraw activated catholyte from the cathode cell.

In a still further form the invention may be said to reside in a unipolar activation cell having a compound electrode, wherein the compound electrode includes a cylindrical inner electrical conductor electrode, a cylindrical outer electrical conductor electrode surrounding the inner electrode and an electrically conducting material in contact with and sandwiched between the inner electrode and the outer electrode, with an anode cell within the cylindrical inner electrode the compound electrode and a cathode cell surrounding the cylindrical outer electrical conductor electrode, means to supply an neutral anolyte to the anode cell and means to withdraw activated anolyte from the anode cell and means to supply an neutral catholyte to the cathode cell and means to withdraw activated catholyte from the cathode cell, a positive terminal of a DC power source connected to the inner cylinder electrode and a negative terminal of the DC power source connected to the outer electrode cylinder.

The unipolar activation cell may include insulating end caps for the cylindrical inner electrode and means to supply the neutral anolyte tangentially to the anode cell and means to withdraw activated anolyte tangentially from the anode cell.

In an alternative form the invention may be said to reside in a fuel cell having an anode cell and a cathode cell, a compound electrode being the anode in the anode cell and a compound electrode being the cathode in the cathode cell, wherein each of the compound electrodes includes an inner electrical conductor electrode contained in an outer electrical conductor electrode and an electrically conducting material in contact with and sandwiched between the inner electrode and the outer electrode, an electrical load connected to the outer electrode of the anode electrode and the negative terminal to the outer electrode of the cathode electrode, the inner electrodes of the anode and the cathode being connected by a wire conductor, means to deliver a first fuel to the anode cell and an oxidant to the cathode cell and means to transfer discharge from the anode cell to the cathode cell and means to transfer the discharge of the cathode cell to the anode cell.

The first fuel may be hydrogen and the oxidant may be oxygen.

### BRIEF DESCRIPTION OF THE DRAWINGS

This then generally describes the invention but to assist with understanding reference will now be made to preferred embodiments of the invention with reference to the accompanying drawings.

In the drawings:

FIG. 1 shows a first embodiment of a compound electrode according to the present invention;

FIG. 2 shows the use of a compound electrode according to this invention in use in an electrochemical cell;

FIG. 3 shows the use of a compound electrode according to this invention in use in a fuel cell;

FIG. 4 shows the use of a compound electrode according to this invention in use in an unipolar electrochemical system; and

FIG. 5 shows the use of a compound electrode according to this invention in use in an alternative unipolar electrochemical system.

### DETAILED DESCRIPTION OF PREFERRED EMBODIMENTS

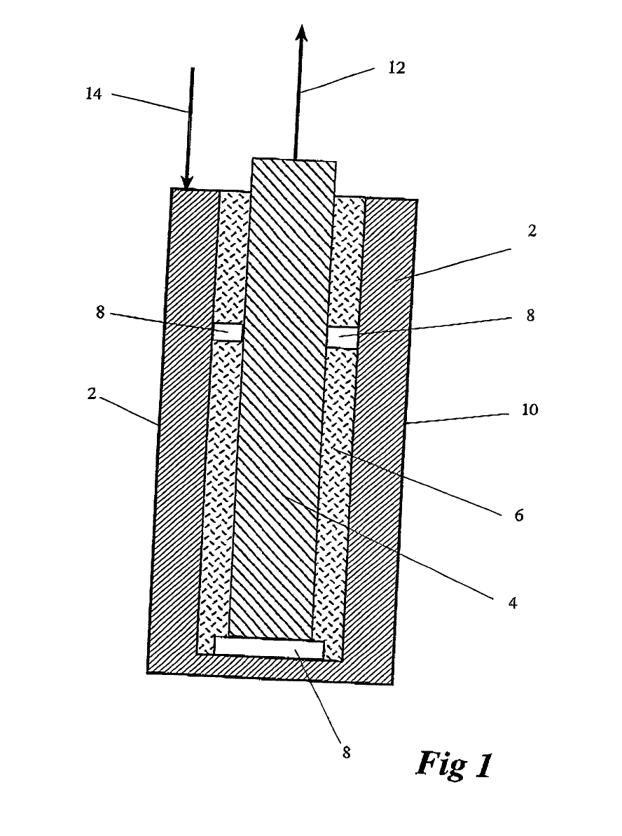

FIG. 1 shows the construction of a compound electrode according to one embodiment of the invention.

The outer electrode 2 is may be an anode or a cathode as required in an electrochemical cell and is made of an electrically conductive material. The inner electrode 4 is also made of an electrically conductive material. An electrically conducting liquid or gel or electrolytic membrane 6 is in contact with and between the outer electrode and the inner electrode so that it allows electrons to pass between the outer electrode and the inner electrode. Non-conductor spacers 8 are provided when liquid or gel is used between the inner and outer electrodes. The liquid or gel must remain stable under the operating voltage and current and temperature of the compound electrode. The electrolytic membrane must be in contact with the inner and outer electrode under all operating conditions of the compound electrode. To ensure good contact, the inner part of the outer electrode and the outer part of the inner electrode may be tapered to fit in planar or cubical electrodes, or conical to fit in circular electrodes. The external surface of the outer electrode 10 may have surfaces that have high specific surface area or coated with protective or catalytic surfaces. Electrical connection 12 is made with the outer electrode and electrical connection 14 is made with the inner electrode.

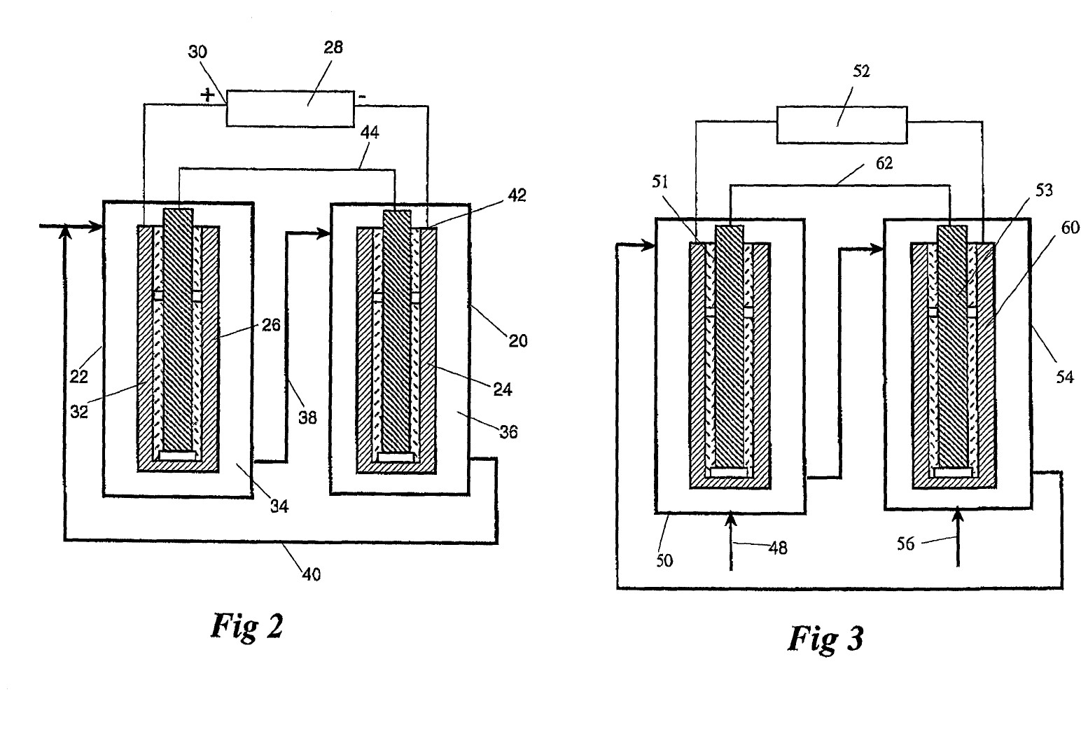

FIG. 2 shows the installation of one embodiment of a compound electrode of the present invention in an electrolytic process.

The electrochemical cell has a cathode cell 20 and an anode cell 22 each having a compound electrode within it. The cathode cell 20 has compound electrode 24 in it. The anode cell 22 each has compound electrode 26 in it.

The positive terminal 30 of a DC power source 28 is connected to the outer electrode 32 of the compound electrode 24 in the anode cell 22 that is in contact with the anolyte 34. Anode reaction occurs because electrons are removed from the anolyte. The anolyte containing the ions is transferred mechanically through line 38 to the cathode cell 20. The electrons are delivered to the outer surface of the cathode compound electrode 24 in contact with the catholyte 36 causing the cathode reaction to occur. The spent catholyte is recycled to the anode cell through line 40 and new anolyte may also be added.

The electronic circuit consists of the DC power source 28 to the cathode outer electrode 42 through the liquid or gel or electrolytic membrane between the cathode outer electrode and the inner electrode to the inner cathode electrode and then to the conductor 44 between the inner cathode electrode and the inner anode electrode to the inner anode electrode and then through the liquid or gel or electrolytic membrane between the inner anode electrode and the anode outer electrode to the anode outer electrode and then back to the DC power source.

The anode and cathode cells may be cubical or cylindrical. There may be several anode cells and cathode cells and the electrolyte flow between these cells may be connected in series or in parallel. There may be several anode or cathode electrodes in the anode cell and cathode cell and these electrodes may be electrically connected in series or in parallel or groups connected in series or parallel and these groups connected in series or parallel connections.

FIG. 3 shows the similar installation of the compound electrodes in a fuel cell process where fuel and an oxidant are consumed to produce electric power.

In the example in FIG. 3, hydrogen 48 is fed into the anode cell 50 where it is catalyzed to the hydrogen ion at the anode electrode 51 and electrons produced travel to the external electrical load 52. The hydrogen ion contained in the electrolyte is transferred to the cathode cell 54 where oxygen 56 is being fed and water is produced at the cathode electrode 53. The cathode reaction consists of the reaction of the hydrogen ion plus the oxygen plus the electron from the anode to form water:

2H⁽⁺⁾+2e⁽⁻⁾+½O₂→H ₂O

The electronic circuit consists of the electrical load 52 to the cathode outer electrode 60 through the liquid or gel or electrolytic membrane between the cathode outer electrode and the inner electrode to the inner cathode electrode and then to the conductor 62 between the inner cathode electrode and the inner anode electrode to the inner anode electrode and then through the liquid or gel or electrolytic membrane between the inner anode electrode and the anode outer electrode to the anode outer electrode and then back to the electrical load 52.

An alternative electrical connection for fuel cells is to connect the inner electrode of the anode to the outer electrode of the cathode and the inner electrode of the cathode to the electrical load.

Compound electrodes may also be used by two methods to carry out unipolar reactions. Unipolar reactions are a new branch of chemistry where electrons are continuously removed or added to a fluid. The fluid may be a liquid or a gas.

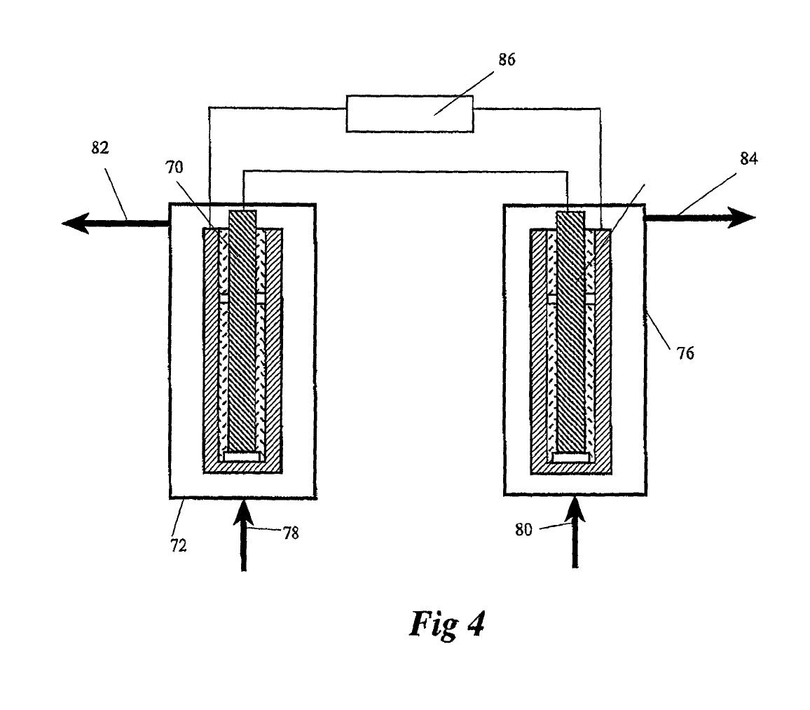

FIG. 4 shows one method of applying the compound electrodes of the present invention to unipolar processes.

The anode compound electrode 70 in the anode cell 72 and the cathode compound electrode 74 in the anode cell 76 are electrically connected by means of the inner electrodes but the anolyte 78 is separate from the catholyte 80. In general, a neutral anolyte is fed to the anode cell 72 where electrons are removed from the fluid. The positively charged anolyte fluid is discharged from the anode cell 72 through line 82 as a final product or to participate in an external reaction before being returned as neutral anolyte to the anode cell. Similarly, the neutral catholyte 80 is fed into the cathode cell 76 and electrons are added to the fluid. The negatively charged catholyte is discharged from the cathode cell 76 through line 84 as final product or to participate in another process. Power is supplied from DC power source 86.

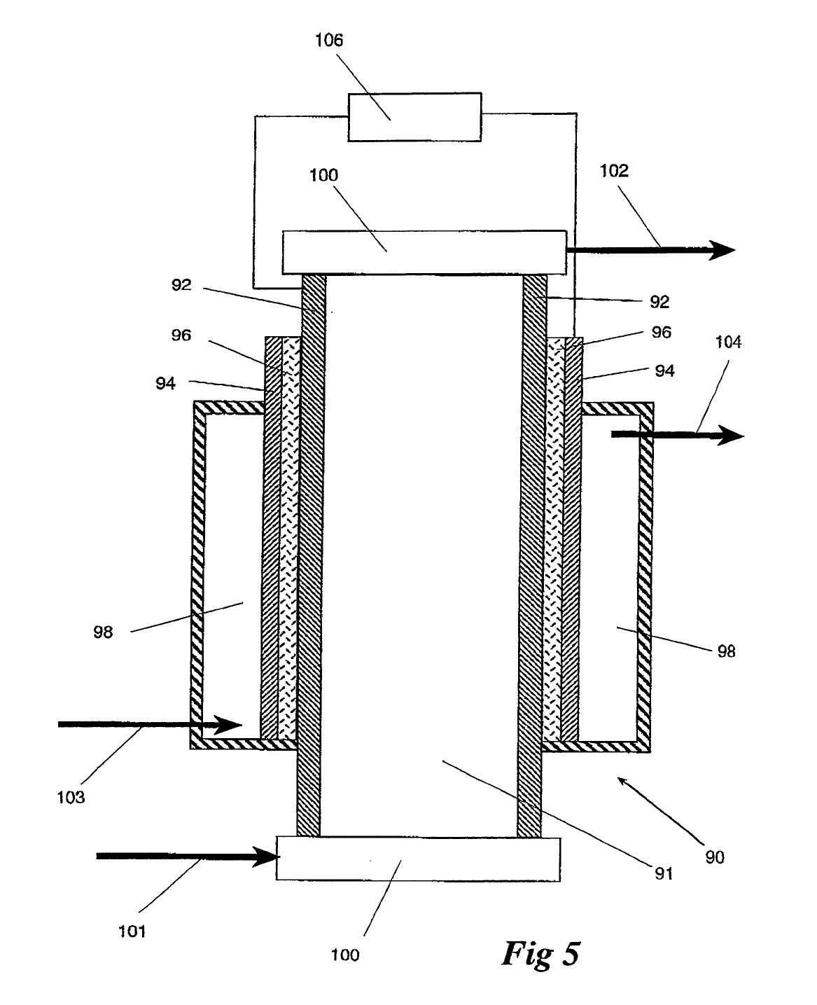

FIG. 5 shows another method of applying a compound electrode of the present invention to unipolar activation.

The compound electrode 90 is turned into a cylindrical electrode. The inner electrode 92 surrounds a cylindrical cell 91 and may be the anode or cathode electrode and the outer electrode 94 is the opposite cathode or anode electrode. The liquid or gel or electrolytic membrane 96 is installed between the two electrodes. An annular outer cell 98 surrounds the outer electrode 94.

In FIG. 5, the inner cylindrical cell 91 is the anode electrode and is fitted with nonconductive end caps 100 to receive a neutral anolyte fluid in tangential feed 101 and discharge the activated anolyte tangentially at the exit end 102. The fluid feed of neutral catholyte 103 to the annular outer cell 98 is also tangentially fed and also discharged tangentially from the annular outer or cell 98 through line 104.

The liquid or gel or electrolytic membrane 96 is held between the inner and outer electrode. The contact surfaces of the electrodes when an electrolytic membrane is used are preferably slightly conical in shape and forced together to maintain a pod contact between the inner and outer electrodes. The outer cylinder of the cell may be made of the same material as the outer electrode but preferably, it should be a nonconductor material such as a plastics material. A positive terminal of a DC power source 106 is connected to the inner cylinder electrode and a negative terminal of the DC power source is connected to the outer electrode cylinder.

The claims defining the invention are as follows

1. A compound electrode for use in electrochemical processes comprising:
an inner electrical conductor electrode contained in an outer electrical conductor electrode,
an electrically conducting material in contact with and sandwiched between the inner electrode and the outer electrode and electrical leads to the inner and outer electrodes for inlet and outlet of electrons.

2. A compound electrode as in claim 1 wherein the electrically conducting material in contact with and sandwiched between the inner electrode and the outer electrode is a liquid.

3. A compound electrode as in claim 1 wherein the electrically conducting material in contact with and sandwiched between the inner electrode and the outer electrode is a gel.

4. A compound electrode as in claim 1 wherein the electrically conducting material in contact with and sandwiched between the inner electrode and the outer electrode is an electrolytic membrane.

5. A compound electrode as in claim I wherein an outer surface of the outer electrode has a high specific surface area.

6. A compound electrode as in claim 1 wherein an outer surface of the outer electrode is coated with material to protect the electrode or to act as a catalyst.

7. A n electrochemical cell having an anode cell and a cathode cell, a compound electrode being the anode in the anode cell and a compound electrode being the cathode in the cathode cell, wherein each of the compound electrodes includes an inner electrical conductor electrode contained in an outer electrical conductor electrode and an electrically conducting material in contact with and sandwiched between the inner electrode and the outer electrode, a positive terminal of a DC power source connected to the outer electrode of the anode electrode and the negative terminal to the outer electrode of the cathode electrode, the inner electrodes of the anode and the cathode being connected to each other by a wire conductor, means to deliver electrolyte to the anode cell and means to transfer discharge from the anode cell to the cathode cell and means to transfer the discharge of the cathode cell to the anode cell.

8. A unipolar activation cell having an anode cell and a cathode cell, a compound electrode being the anode electrode in the anode cell and a compound electrode being the cathode electrode in the cathode cell, wherein each of the compound electrodes includes an inner electrical conductor electrode contained in an outer electrical conductor electrode and an electrically conducting material in contact wit h and sandwiched between the inner electrode and the outer electrode, a positive terminal of a DC power source connected to the outer electrode of the anode electrode and the negative terminal to the outer electrode of the cathode electrode, the inner electrodes of the anode and the cathode being connected to each other by a wire conductor, means to supply an neutral anolyte to the anode cell and means to withdraw activated anolyte from the anode cell and means to supply a neutral catholyte to the cathode cell and means to withdraw activated catholyte from the cathode cell.

9. A unipolar activation cell having a compound electrode, wherein the compound electrode includes a cylindrical inner electrical conductor electrode a cylindrical outer electrical conductor electrode surrounding the inner electrode and an electrically conducting material in contact with and sandwiched between the inner electrode and the outer electrode, with an anode cell within the cylindrical inner electrode the compound electrode and a cathode cell surrounding the cylindrical outer electrical conductor electrode, means to supply an neutral anolyte to the anode cell and means to withdraw activated anolyte from the anode cell and means to supply an neutral catholyte to the cathode cell and means to withdraw activated catholyte from the cathode cell, a positive terminal of a DC power source connected to the inner cylinder electrode and a negative terminal of the DC power source connected to the outer electrode cylinder.

10. A unipolar activation cell as in claim 9 further including insulating end caps for the cylindrical inner electrode and means to supply the neutral anolyte tangentially to the anode cell and means to withdraw activated anolyte tangentially from the anode cell.

11. A fuel cell having an anode cell and a cathode cell, a compound electrode being the anode in the anode cell and a compound electrode being the cathode in the cathode cell, wherein each of the compound electrodes includes an inner electrical conductor electrode contained in an outer electrical conductor electrode and an electrically conducting material in contact with and sandwiched between the inner electrode and the outer electrode, an electrical load connected to the outer electrode of the anode electrode and the negative terminal to the outer electrode of the cathode electrode, the inner electrodes of the anode and the cathode being connected by a wire conductor, means to deliver a first fuel to the anode cell and an oxidant to the cathode cell and means to transfer discharge from the anode cell to the cathode cell and means to transfer the discharge of the cathode cell to the anode cell.

12. A fuel cell as in claim 11 wherein the first fuel is hydrogen and the oxidant is oxygen.
